(19) United States
(12) Patent Application Publication
(10) Pub. No.: US 2025/0252511 A1
(43) Pub. Date: Aug. 7, 2025

(54) VIRTUAL POWER FLUID PLANT, OPERATION METHOD THEREOF, AND INPUT RESOURCE EVALUATION SYSTEM

(71) Applicant: ORGANO CORPORATION, Tokyo (JP)

(72) Inventor: Mitsuru YODEN, Tokyo (JP)

(73) Assignee: ORGANO CORPORATION, Tokyo (JP)

(21) Appl. No.: 18/857,055

(22) PCT Filed: Mar. 28, 2023
(86) PCT No.: PCT/JP2023/012677

§ 371 Date: Oct. 15, 2024

(30) Foreign Application Priority Data
Apr. 18, 2022 (JP) 2022-068028
Apr. 18, 2022 (JP) 2022-068029

(51) Int. Cl. G06Q 50/06; G06Q 10/0631

(52) U.S. Cl. CPC G06Q 50/06; G06Q 10/06315

(57) ABSTRACT

A virtual power fluid plant includes: a plurality of electrical-related facilities that are installed in a predetermined area and that perform at least one of supplying, utilizing, and storing electrical energy; a plurality of fluid-related facilities that are installed in the predetermined area and that perform at least one of supplying, processing, and storing a fluid resource; operation plan creation means that creates an operation plan for at least one electrical-related facility and at least one fluid-related facility; and control means that controls an operation of the at least one electrical facility and the at least one fluid facility based on the operation plan created by the operation plan creating means.

### TECHNICAL FIELD

This application claims the benefits of priority based on Japanese Patent Application No. 2022-68028 filed on Apr. 18, 2022, and Japanese Patent Application No. 2022-68029 filed on Apr. 18, 2022, and incorporates by citation all the disclosures of those applications.

The present invention relates to a virtual power fluid plant that adjusts the balance between the supply and consumption of electrical energy and the supply and consumption of a fluid resource in a predetermined area, and to an operating method thereof. The present invention also relates to a system for evaluating the amounts of energy used and the fluid resource usage amounts related to products and services in a virtual power fluid plant that adjusts the balance between the supply and consumption of electrical energy and the supply and consumption of the fluid resource in a specified area.

### BACKGROUND OF ART

In recent years, various efforts have been made regarding energy management systems (EMS) for the purpose of efficiently operating distributed energy equipment. Patent Document 1 discloses an operation plan creation device for a distributed energy system that can create an operation plan that enables efficient energy interchange. Patent Document 2 discloses a control device for a virtual power plant (VPP) that appropriately controls the charging and discharging operations of an entire group of vehicles that constitute the VPP in accordance with the state of the vehicles.
Patent Document 1: Japanese Patent No. 6520462
Patent Document 2: Japanese Patent Laid-open No. 2021-191133
Patent Document 3: Japanese Patent Laid-open No. 2002-92096
Patent Document 4: Japanese Patent No. 5159729

### SUMMARY OF THE INVENTION

The devices disclosed in Patent Documents 1 and 2 focus on efficient use of electrical energy. On the other hand, regarding a fluid resource, which is an infrastructure comparable to electrical energy, individual facilities are operated independently, and no efforts have been made to jointly operate multiple facilities in the same area. Furthermore, no efforts have been made to operate electric energy and a fluid resource in a coordinated manner.

An object of the present invention is to provide a virtual power fluid plant that can simultaneously manage electrical energy and a fluid resource in an area by operating multiple electrical-related facilities and multiple fluid-related facilities in the area in a coordinated manner.

A virtual power fluid plant of the present invention adjusts the balance between the supply and consumption of electrical energy and the supply and consumption of a fluid resource in a predetermined area. The virtual power fluid plant comprises a plurality of electrical-related facilities that are installed in the predetermined area and that perform at least one of supplying, utilizing, and storing electrical energy; a plurality of fluid-related facilities that are installed in the predetermined area and that perform at least one of supplying, treating, and storing the fluid resource; an operation plan creation means for creating an operation plan for at least one electrical-related facility and at least one fluid-related facility; and a control means for controlling the operation of the at least one electrical-related facility and at least one fluid-related facility based on the operation plan created by the operation plan creation means.

According to the present invention, a virtual power fluid plant can be provided that can simultaneously manage electrical energy and a fluid resource in an area by operating multiple electrical-related facilities and multiple fluid-related facilities in the area in a coordinated manner. The above and other objects, features, and advantages of the present invention will become apparent from the following description with reference to the accompanying drawings that illustrate examples of the present invention.

### BRIEF DESCRIPTION OF THE DRAWINGS

FIG. 1 is a schematic diagram of a virtual power water plant according to a first embodiment of the present invention.

FIG. 2 is a schematic diagram of a virtual power water plant according to a second embodiment of the present invention.

FIG. 3A is a conceptual diagram showing various steps in the life cycle of an article.

FIG. 3B is a conceptual diagram showing various steps in the life cycle of an article.

FIG. 4A is a conceptual diagram showing the energy usage amount in the life cycle of an item.

FIG. 4B is a conceptual diagram showing the energy usage amount in the life cycle of an article.

FIG. 4C is a conceptual diagram showing the energy usage amount in the life cycle of an article.

FIG. 4D is a conceptual diagram showing the energy usage amount in the life cycle of an article.

FIG. 4E is a conceptual diagram showing the energy usage amount in the life cycle of an article.

FIG. 5 is a schematic diagram showing a specific example to which the first embodiment is applied.

### DESCRIPTION OF THE EMBODIMENTS

### First Embodiment

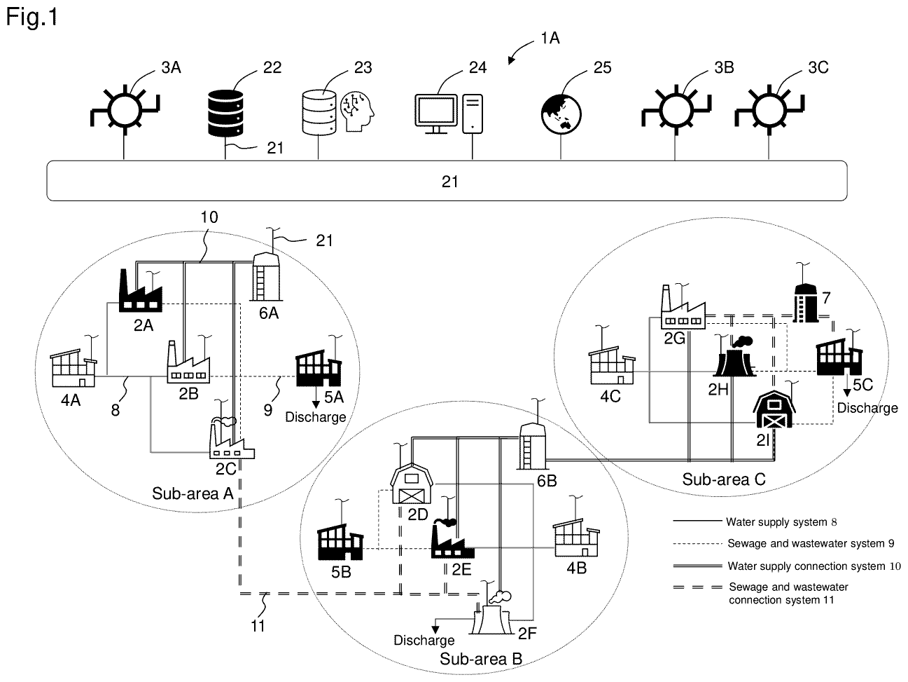

With reference to FIG. 1, a virtual power fluid plant (VPFP) according to the first embodiment of the present invention will be described. In this embodiment, since the fluid resource is water, the virtual power fluid plant is called virtual power water plant (VPWP) 1A. VPWP 1A adjusts the balance between the supply and consumption of electrical energy and the supply and consumption of the fluid resource in a predetermined area. The predetermined area is not particularly limited, but the predetermined area is preferably a relatively limited area in order to avoid excessive investment for constructing a piping network. The predetermined area is divided into a plurality of sub-areas (sub-areas A to C in this embodiment).

VPWP 1A has a plurality of electricity-related facilities installed in the predetermined area and a power transmission and distribution network (not shown) that interconnects the plurality of electricity-related facilities. The electricity-related facilities perform at least one of supplying, utilizing, and storing electrical energy. The supply of electrical energy is typically performed by power plants 3A to 3C operated by an electric power company or the like. In this embodiment, individual power plants 3A to 3C are regarded as components of the electricity-related facilities, but the electric power company can also be considered to be a component of the electricity-related facilities. The supply of electrical energy is also performed by factories and homes equipped with energy storage equipment and solar panels. The use of electrical energy is synonymous with the consumption of electrical energy and is carried out by facilities and equipment that use electrical energy for various purposes (hereinafter, such facilities and equipment are referred to as power utilization facilities). The storage of electrical energy is mainly performed by energy storage equipment. One electrical facility may perform two or more of the following functions: supply, utilization, and storage of electrical energy. For example, energy storage equipment equipped with a rechargeable storage battery supplies and stores electrical energy.

VPWP 1A has a plurality of fluid-related facilities installed in a predetermined area and piping networks 8 to 11 that interconnect the plurality of fluid-related facilities. The fluid-related facilities perform at least one of supplying, treating, and storing a fluid resource. Many facilities (e.g., houses, apartment buildings, buildings, stores, public facilities, equipment, factories, etc.) combine electrical-related facilities and fluid-related facilities.

The fluid resource (water in this embodiment) is usually supplied by purified water production facilities 4A to 4C such as water purification plants in a water and sewerage system. Purified water production facilities 4A to 4C are examples of purified water supply facilities. Purified water production facilities 4A to 4C also include equipment (for example, wastewater treatment equipment that is provided in a factory) that treats wastewater to produce purified water (industrial water or recycled water). The treatment of the fluid resource includes using supply water as part of a product, washing water, domestic water, industrial water, etc., further purifying the supply water for specific uses (production of pretreated water), and post-treating wastewater generated after use of the supply water before discharge (production of post-treated water). Facilities that perform at least a part of these treatments are referred to as water treatment facilities 2A to 2I. Representative examples of water treatment facilities include, but are not limited to, houses, factories (machinery, chemical, food, pharmaceutical, etc.), farms, power plants, pure water production plants, office buildings, and public facilities. The water treatment facilities may have purified water feed equipment capable of feeding to the outside purified water, pretreated water, or post-treated water that was supplied to the water treatment facilities. The purified water feed equipment is composed of, for example, a storage tank for storing purified water supplied from the outside or purified water that has been pre-treated or post-treated, and a water feed pump. If the unused purified water stored in the storage tank can be supplied to other water treatment facilities, a water treatment facility can also function as a purified water supply facility. For example, if water from a clean water storage tank installed in an apartment house can be supplied to the outside, the apartment building is both a water treatment facility and a purified water supply facility. A water treatment facility can also treat sewage (foul water and domestic wastewater) discharged from other water treatment facilities and wastewater discharged from factories (collectively referred to as sewage and wastewater). Sewage treatment is carried out at sewage treatment plants in a water and sewerage system, but wastewater treatment is often carried out in factories. The facilities for performing sewage and wastewater treatment are referred to as sewage and wastewater treatment facilities 5A to 5C. Storage of a fluid resource is carried out in two types of facilities depending on the subject; one being a purified water storage facility that stores unused purified water supplied from the water treatment facility, and the other being a sewage and wastewater storage facility that stores sewage and wastewater discharged from the water treatment facility. In the above example of the apartment house, the apartment house is also a purified water storage facility.

VPWP 1A includes database 22, operation plan creation server 23, control server 24, and Internet browsing terminal 25. In addition, VPWP 1A includes communication network 21 (an example of a communication line) that interconnects a plurality of electrical-related facilities, a plurality of fluid-related facilities, database 22, operation plan creation server 23, control server 24, and Internet browsing terminal 25. Communication network 21 is an Internet line, an intranet line, or the like, but may also be a power transmission and distribution network. Furthermore, database 22, operation plan creation server 23, control server 24, and Internet browsing terminal 25 may be integrated in part or as a whole. In this case, communication network 21 includes a data bus inside the server.

Database 22 is an example of a storage means and is composed of an information processing device such as a workstation. Database 22 can write and read electronic information via communication network 21. Database 22 stores information on the facilities and power transmission/distribution/communication/piping networks that constitute VPWP 1A via communication network 21 at a predetermined interval or at any timing. By way of example, database 22 stores the following operational related data, including operation data for a plurality of electrical-related facilities and a plurality of fluid-related facilities:
Purified water production capacity of the purified water production facilities.
Storable amount of purified water of the purified water storage facilities (Storage capacity of the purified water storage facilities—Amounts currently stored in the purified water storage facilities)
Feedable amount of purified water of purified water feed equipment.
Fluctuations over time in demand for purified water at the water treatment facilities
Amount of sewage and wastewater discharged from each water treatment facility
Sewage and wastewater treatment capacity of the sewage and wastewater treatment facilities.
Storable amounts of sewage and wastewater of the sewage and wastewater storage facilities (Storage capacities of the sewage and wastewater storage facilities—Amounts currently stored in the sewage and wastewater storage facilities)
Water quality requirements for each water treatment facility
Water quality of sewage and wastewater discharged from each water treatment facility
Fluctuations over time in electricity charges and electricity costs. Fluctuations over time in electricity supply and demand and status of electricity supply and demand
Type of electrical energy
Adjustable power capacity
Operational status of each facility (including operating hours, regular inspections, repair information, etc.)
State of charge and discharge (SOC) of the energy storage equipment
General information that may affect the operation of the above facilities (information regarding weather, politics, economics, social issues, etc.)

Among these data, the types of electrical energy are preferably classified into a plurality of energy categories from the viewpoint of greenhouse gas emissions, power generation methods, and the like. These energy classifications can be used in combination, or can be applied in conjunction with each other. As an example, the following energy classifications can be mentioned: (Energy classification from the viewpoint of greenhouse gas emissions)·
Green energy: Energy that does not emit greenhouse gases
Gray energy: Energy that emits greenhouse gases.
Blue energy: Energy that reduces greenhouse gas emissions by recovering and utilizing greenhouse gases emitted during the production process of grey energy
   (Energy Classification from the Viewpoint of Power Generation Method)
LNG thermal power plants
Coal-fired power plants
Oil-fired power plants
Nuclear power plants
Hydroelectric power plants
Solar power plants
Wind power plants
Geothermal power plants

Operation plan creation server 23 is an example of an operation plan creation means and is composed of an information processing device such as a workstation and artificial intelligence such as XAI. Operation plan creation server 23 creates an operation plan for at least one electricity-related facility and at least one fluid-related facility based on the operation-related data stored in database 22. Operation plan creation server 23 acquires various operation-related data from database 22 via communication network 21 and predicts and creates an optimal operation pattern model for each fluid-related facility according to the status of electricity supply and demand, electricity charges, status of water supply and demand, water quality, state of charge and discharge of the energy storage equipment, inflow and outflow status of storage tanks, past performance, and the like. Operation plan creation server 23 visualizes the optimal operation pattern model according to necessity. In addition, operation plan creation server 23 compares and evaluates the prediction by the optimal operation pattern model with the actual results, and outputs points of improvements (repairs, modifications, renewals, additions, etc. of related facilities and systems).

Control server 24 is an example of a control means and is constituted by an information processing device such as a workstation. Control server 24 obtains an operation plan (optimal operation pattern model) created by operation plan creation server 23 from operation plan creation server 23 via communication network 21 and transmits operation control commands to at least one electrical-related facility and at least one fluid-related facility via communication network 21. Control server 24 controls the operation of at least one electrical-related facility and at least one fluid-related facility based on the operation plan. Control server 24 also monitors whether the electrical-related facility and fluid-related facility are operating in a manner that deviates from the operation plan. Control server 24 instructs operation plan creation server 23 to modify the operation plan as necessary and transmits alarms to the electricity-related facility and the fluid-related facility.

### Operation Example 1

An example of a purified water operation is next described as an example of an operation plan for a fluid-related facility (water operation plan). A water operation plan is prepared in sub-area units. When a plurality of water treatment facilities is provided in a certain area, the individual water treatment facilities are conventionally independent and not interdependent on each other. For this reason, the purified water production facilities are required to produce purified water with a surplus to meet the water demand of individual water treatment facilities, and this requirement may result in an excessive amount of purified water being held across the entire sub-area. This requirement also leads to excessive consumption of electrical energy for producing purified water. Operation plan creation server 23 creates a water operation plan based on the purified water production capacity of the purified water production facilities, the purified water demand of each water treatment facility, the feedable amount of the purified water of the purified water feed equipment, the storable amount of the purified water storage of the purified water storage facilities, etc. The water operation plan includes the following items:
Supply of the purified water from the purified water production facilities to the water treatment facilities
Sharing the purified water between the water treatment facilities.
Supply of the purified water from the purified water production facility and water treatment facilities to the purified water storage facility, and storage of the purified water in the purified water storage facility
Supply of the purified water from a purified water storage facility to each water treatment facility

In sub-area A, water treatment equipment 2A to 2C are connected to purified water production facility 4A by water supply system 8 and are connected to sewage and wastewater treatment facility 5A by sewerage and wastewater system 9. Water treatment equipment 2A to 2C are interconnected by water supply connection system 10 and are also connected to purified water storage facility 6A. A portion of the purified water (including pre-treated or post-treated purified water) held by each water treatment equipment 2A to 2C is stored in purified water storage facility 6A depending on the demand for purified water of each water treatment facility and the storable amount of purified water of purified water storage facility 6A. When the demand for purified water is tight in some water treatment equipment (e.g., water treatment equipment 2A), purified water can be supplied from another water treatment facility (e.g., water treatment facility 2B) that has sharable purified water or purified water storage facility 6A. Since the amount of purified water produced in purified water production facility 4A is leveled, the load on purified water production facility 4A is reduced, and water and electricity savings are realized. By mutually sharing pretreated water or post-treated water among water treatment equipment 2A to 2C, the water treatment load of water treatment equipment 2A to 2C as a whole is reduced, and water and electricity savings are realized. Since amount of sewerage and wastewater discharged from sub-area A is also reduced, the load on sewerage and wastewater treatment facility 5A is reduced, and water and electricity savings are realized. Adjustable power is also secured by saving electricity at each facility.

These water operation plans are preferably determined based on electricity costs, power demand, and purified water demand. For example, electricity costs can be saved by having a purified water production facility produce purified water at times when electricity costs are low, storing the produced purified water in a purified water storage facility, and then supplying the purified water stored in the purified water storage facility to a water treatment facility at times when electricity costs are high. Alternatively, a purified water production facility may produce purified water at times when electricity demand is low, store the produced purified water in a purified water storage facility, and supply the purified water stored in the purified water storage facility to a water treatment facility at times when electricity demand is high. In this case, electricity demand can be leveled, whereby CO₂ emissions can be reduced. Alternatively, a purified water production facility may produce purified water at times when demand for purified water is low, the produced purified water may be stored in a purified water storage facility, and the purified water stored in the purified water storage facility may be supplied to a water treatment facility at times when demand for purified water is high. Since the amount of purified water produced can be leveled, the load on the purified water production facility can be reduced to realize a savings of and water and electricity.

### Operation Example 2

An example of the operation of a sewage and wastewater treatment is next described as another example of a water operation plan. This water operation plan is prepared in sub-area units. When a plurality of water treatment facilities is provided in a certain area, conventionally, the individual water treatment facilities are independent and not interdependent on each other. For this reason, the sewage and wastewater treatment facility must operate with sufficient capacity to enable treatment of sewage and wastewater from individual water treatment facilities. This requirement also leads to excessive consumption of electrical energy for sewage and wastewater treatment. Operation plan creation server 23 creates a plan to distribute sewage and wastewater from each water treatment facility to the sewage and wastewater treatment facility and sewage storage facility based on such factors as the amount of sewage and wastewater from each water treatment facility, the sewage and wastewater treatment capacity of the sewage and wastewater treatment facility, and the storable amount of sewage and wastewater of the sewage and wastewater storage facility. In the water operation plan, the ratio of the sewage and wastewater to be distributed to the sewage and wastewater treatment facility is preferably increased at times when any one of the electricity cost, electricity demand, and the amount of sewage and wastewater is low, and the ratio of the sewage and wastewater to be distributed to the sewage and wastewater storage facility is preferably increased at times when any one of the electricity cost, electricity demand, and the amount of sewage and wastewater water is high. For example, water treatment facilities 2G to 2I in area C are connected to sewage and wastewater treatment facility 5C by sewage and wastewater system 9 and are also connected to sewage and wastewater storage facility 7 by sewage and wastewater connection system 11. Therefore, the sewage and wastewater can be distributed to sewage and wastewater treatment facility 5C and sewage and wastewater storage facility 7.

### Operation Example 3

An example of the operation of reuse of sewage and wastewater is next described as another example of a water operation plan. The water operation plan is prepared in sub-area units. When a plurality of water treatment facilities is provided in a certain area, conventionally, the individual water treatment facilities are independent and not interdependent on each other. For this reason, sewage and wastewater from each water treatment facility is treated at the facility or treated and discharged at a sewage and wastewater treatment facility. Therefore, sewage and wastewater from each water treatment facility is not reused. However, since the water quality of sewage and wastewater varies and the water quality required by a water treatment facility varies, sewage and wastewater from one water treatment facility may possibly be used as supply water for another water treatment facility. In other words, by treating reusable sewage and wastewater, the sewage and wastewater treatment facility may be consuming pointlessly. Operation plan creation server 23 creates a water operation plan based on such factors as the required water quality of each water treatment facility, the water quality of sewage and wastewater of each water treatment facility, and the storable amount of sewage and wastewater of sewage and wastewater storage facilities. The water operation plan includes the following items:
Supply of sewage and wastewater discharged from some water treatment facilities to other water treatment facilities
Storage of sewage and wastewater discharged from some water treatment facilities in a sewage and wastewater storage facility
Supply of sewage and wastewater stored in the sewage and wastewater storage facility to other water treatment facilities

For example, since water treatment equipment 2D to 2F in area B is interconnected by sewage and wastewater communication system 11, the sewage and wastewater can be mutually reused. As a result, the reduction of the amount of treatment at sewage and wastewater treatment facility 5B can reduce the load on sewage and wastewater treatment facility 5B. In addition, sewage and wastewater treatment can be performed mutually between sewage and wastewater treatment facility 5B and water treatment equipment 2D to 2F in area B (in particular, treatment in water treatment equipment 2F with discharge equipment). Adjustable power is also secured by saving electricity at each facility.

### Operation Example 4

Another example of the operation of purified water is next described. as an example of a water operation plan. In this operation example, it is assumed that the manager of a water treatment facility will adopt various water-saving methods. The amount of water saved may be determined, for example, in a contract between the water treatment facility and the owner (or operator) of VPWP 1A (or purified water production facility). Under the contract, the manager of the water treatment facility is required to save water for a certain period of time (e.g., several hours or days) at the request of the holder of the VPWP 1A. The date of the certain period is not notified in advance, and may be notified immediately before (for example, a few hours before) the obligation is to be fulfilled. The contents of the contract, particularly the amount of water saved and the water saving period, are stored in database 22, and operation plan creation server 23 can create a water operation plan by referring to this contract. In other words, the amount of water saved and the water saving period based on the contract form part of the operation-related data. The amount of water saved has the nature of an adjustment amount for water resources, that is, a virtual purified water production capacity, and therefore the amount of water saved can be made an object of transaction in the market in the future. In addition, the electricity saved with the water saving can be used as adjustment power. The adjustment power is already recognized as the amount of virtual power generation in VPP and is subject to trading in the capacity market. In this operation method, the amount of adjustment of electricity and water resources that have been made a set of power and water saving can be comprehended and utilized.

For example, the following methods can be cited as measures taken by water treatment facilities when such water and power saving are obligatory:
(a) General energy-saving measures (energy saving of mechanical elements, waste heat recovery, etc.)
(b) Optimization of plant operations
   Planned shutdown, suspension, standby, intermittent operation, and output suppression operations of power equipment (pumps, blowers, compressors, agitators, heaters, electric valves, etc.)
   Process deletion, process simplification, and process time shortening.
   Optimization of the treatment amount (adjustment of treatment speed according to water quality, selection of treatment system, etc.)
   Operation that takes into account the supply and demand of electricity (off-peak treatment, installation of storage tanks, etc.)
   Layout change
(c) Extraction of unused energy.
   Improvement of the efficiency of solar power generation (review of the site, reinforcement of structures (mounts, racks, supports), etc.)
   Utilization of the equipment height difference and system pressure difference in small hydroelectric/pressure energy generation
   Biogas power generation and hydrogen production from sewage and wastewater sludge
(d) Maintenance and switching of control mode

A means for switching between normal operation mode and power-saving mode (since the time for switching to the power-saving mode is limited, the power-saving mode is set in advance and a switching means is provided for quickly entering the power-saving mode)

In the above operation examples, the water operation plans are created in sub-area units, but water operation plans can also be created between sub-areas. This approach allows water to be shared between sub-areas. For example, if the peak of electricity demand is in the afternoon in sub-area B and in the morning in sub-area C, during the afternoon, a portion of the purified water supplied from purified water production facility 4C to water treatment facilities 2G to 21 in sub-area C can be stored in purified water storage facility 6B in sub-area B via water supply connection system 10. This allows the power load to be leveled and purified water to be produced for sharing at minimal cost. Furthermore, in the morning, purified water stored in purified water storage facility 6B in sub-area B can be supplied to water treatment facilities 2G to 2I in sub-area C. In this way, by using purified water stored in purified water storage facilities in different sub-areas in accordance with the peak of power demand, the power load can be equalized and the maximum adjustment power can be guaranteed. Similarly, if the peak of treatment amount of sewage and wastewater treatment facility 5B in sub-area B is in the morning, the sewage and wastewater from sub-area B can be temporarily stored in sewage and wastewater storage facility 7 in sub-area C in the morning, and the sewage and wastewater stored in sewage and wastewater storage facility 7 can be supplied to sewage and wastewater treatment facility 5B in the afternoon. As a result, the load of sewage and wastewater treatment can be leveled, and adjustment power can be guaranteed by reducing the load on the sewage and wastewater treatment facility.

Furthermore, by interconnecting water treatment equipment 2C in sub-area A and water treatment equipment 2D to 2F in sub-area B via sewage and wastewater connection system 11, the sewage and wastewater from sub-area A can be treated or reused in water treatment equipment 2D to 2F in sub-area B (particularly in water treatment equipment 2F). Consequently, adjustment power can be secured due to load reduction of water treatment equipment 2C and 2D-2F as a whole. In addition, the total amount of water supply used in sub-area A and sub-area B and the total amount of sewage and wastewater discharged in the same areas are reduced, and adjustment power can be secured by reducing the load on purified water treatment facilities 4A and 4B and sewage and wastewater treatment facilities 5A and 5B in two sub-areas A and B. Similarly, by connecting water treatment equipment 2D to 2F in sub-area B and water treatment equipment 2G to 2I in sub-area C with water supply communication system 10 and effectively sharing and utilizing water, adjustment power by load reduction of water treatment equipment 2D-2I can be secured as a whole. In addition, the total amount of water supply used in sub-area B and sub-area C and the total amount of wastewater discharged in the same areas can be reduced, and adjustment power can be secured by reducing the load on purified water facilities 4B and 4C and sewage and wastewater treatment facilities 5B and 5C in two sub-areas B and C.

As described above, the present embodiment realizes power adjustment functions such as equalizing the power load, adjusting the power demand during power shortages, and absorbing excess supply of renewable energy, and water resource adjustment functions such as reducing the load on fluid-related facilities and effectively using and accommodating water. The synergistic effect of both types of functions enables effective power and water conservation. In addition, this embodiment contributes to the provision of emergency water infrastructure, the construction of an efficient distributed sewage and wastewater system, and the reduction of carbon.

### Second Embodiment

In recent years, various proposals have been made for improving the operation of equipment and saving energy. Patent Document 3 discloses a system that periodically collects information from each element of equipment and uses the collected information to support proper operation of the equipment. Patent Document 4 discloses a system for achieving a good balance between promoting energy conservation in equipment and improving business efficiency. The systems disclosed in Patent Documents 3 and 4 are designed to save energy by improving the operation of equipment, and do not aim to save energy over the entire life cycle of the equipment. Achieving further energy saving requires energy conservation throughout the life cycle of the target products and services. Further, since fluid resource such as water are valuable resources as well as energy, it is desirable to evaluate them integrally. The object of the present embodiment is to provide a system for identifying and evaluating the amount of energy and fluid resources used in various processes related to a product or service.

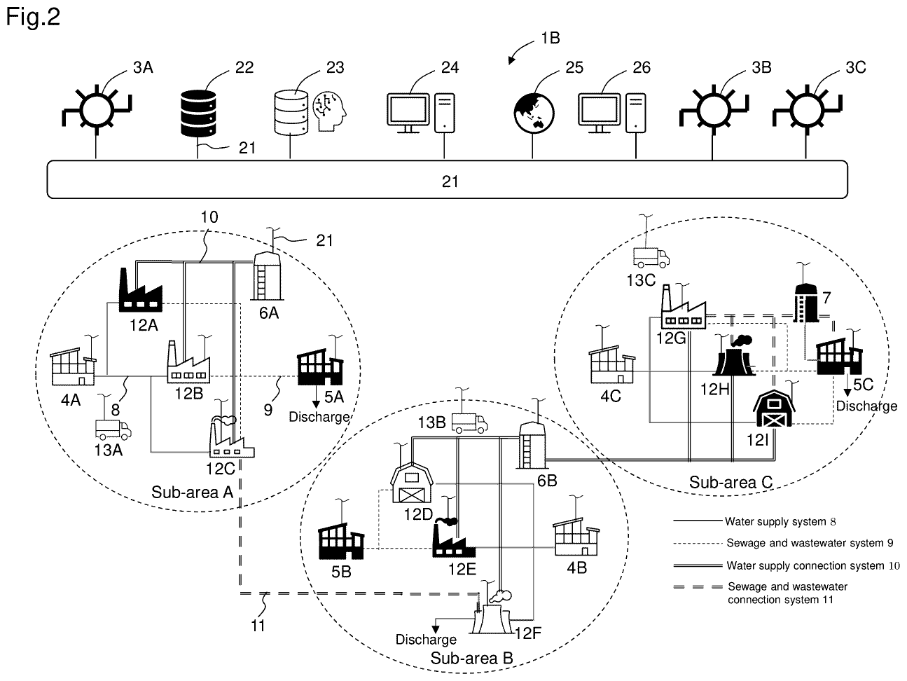

An input resource evaluation system according to the second embodiment of the present invention will next be described. The input resource evaluation system uses the same VPFP as in the first embodiment. FIG. 2 shows the VPFP applied in this embodiment. The fluid resource used in the VPFP of this embodiment is water, and therefore the VPFP is a VPWP. The configuration of the VPWP, for which description is here omitted, is the same as that of the VPWP in the first embodiment. In FIG. 2, water treatment equipment 2A to 2I is replaced with more specific equipment 12A to 12I (see the explanation of the symbols).

The input resource evaluation system targets products or services. The products targeted by the input resource evaluation system use water and electric power in any process of their life cycle. Water and electric power may be used at different times. The life cycle of the products includes the following processes:
Processes related to manufacturing (including processing, assembly, cleaning, intermediate transportation, etc.) (initial processes)
Processes related to operation (including use and repair) (running processes)
Processes related to reuse, recycling, disposal, etc. (disposal processes)

The “services” covered by the input resource evaluation system are processes other than those mentioned above, and actions that do not involve products (e.g., the provision of hot springs, public baths, swimming pools, and water-based attractions at amusement parks, etc.) are also included in the services in this embodiment. Hereinafter, products will be described as examples. VPWP 1B shown in FIG. 2 includes transportation means 13A to 13C as well as facilities related to initial processes, running processes, and disposal processes of products. These facilities and transportation means can transmit relevant data to database 22 via communications network 21.

The input resource evaluation system includes database 22 and input resource calculation server 26. Input resource calculation server 26 is interconnected to database 22, operation plan creation server 23, control server 24, and Internet browsing terminal 25 via communication network 21. Database 22 is connected by communication network 21 to each facility 12A to 12I (or facilities related to the provision of services) related to the process of the life cycle of the products and stores the energy usage amount and the fluid resource usage amount in each facility online. The energy usage amounts and the fluid resource usage amounts are stored in database 22 for each initial process, running process, and disposal process. Database 22 can store the following data in addition to the data described in the first embodiment:
Energy usage amounts and fluid resource usage amounts at each facility
Factory-specific information (manufacturing product identification information such as manufacturing lot number, production quantity per unit time, etc.)
Data for each transportation means 13A to 13C (amount of fuel used, etc.)

Input resource calculation server 26 is an example of an input resource calculation means and is composed of an information processing apparatus such as a workstation. Input resource calculation server 26 integrates the energy usage amounts and the fluid resource usage amounts stored in the database 22 for each process and calculates the total energy usage amount and the total fluid resource usage amount. That is, input resource calculation server 26 calculates the energy usage amounts and the fluid resource usage amounts in each process in the manufacturing, operation, recycling, and disposal of the products and the total energy usage amount and the total fluid resource usage amount that are obtained by integrating these amounts. The energy usage amounts and the fluid resource usage amounts for products and services are calculated for each unit of products and services. For example, when ten products are manufactured at the same time, the total energy usage amount and the total fluid resource usage amount per item are calculated. For products and services that are distributed in a fixed volume or weight, the total energy usage amount and the total fluid resource usage amount per unit volume and unit weight, etc. are calculated. When a part is replaced for maintenance, the energy usage amount of the new part is added to the energy usage amount of the old part. Input resource calculation server 26 further includes classification means for classifying an energy usage amount into a plurality of energy categories (green energy, blue energy, gray energy) from the viewpoint of greenhouse gas emissions. The energy categories identified by the classification means are stored in database 22 for each step. For details of the energy intervals, refer to the first embodiment. The classification means can be provided as a part of the program in input resource calculation server 26.

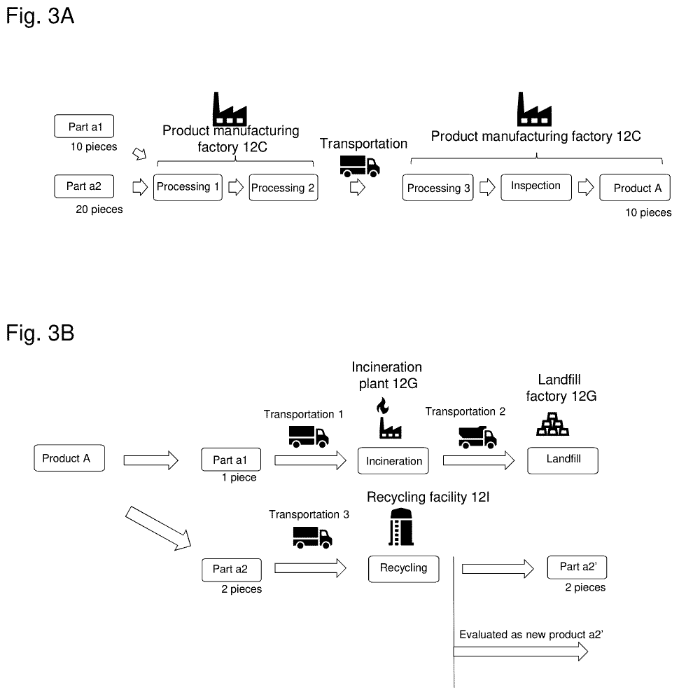

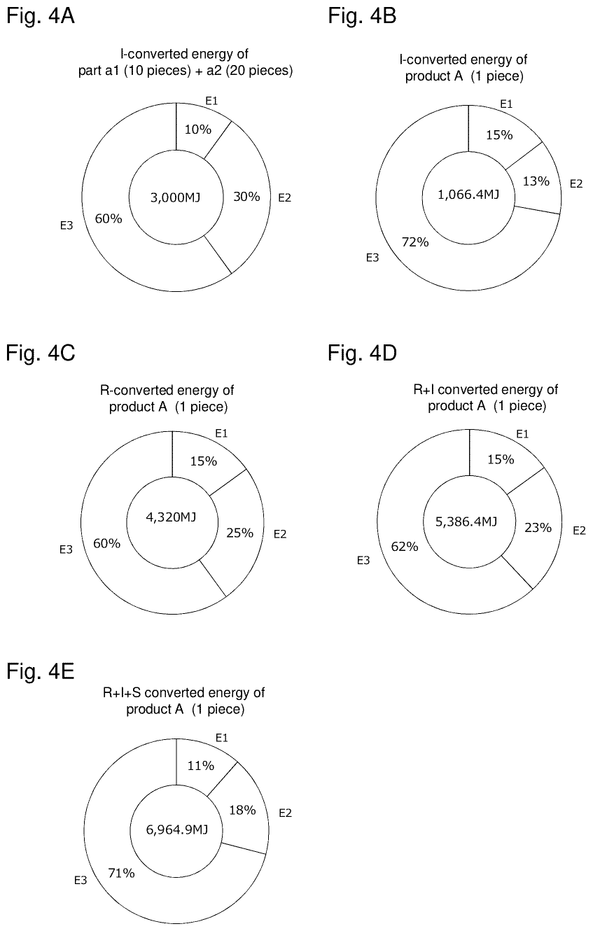

The energy usage amount will be explained using a specific example. FIGS. 3A to 4E show examples of calculations of the life-cycle energy of item A, that is, the energy usage amounts (input resources) in the initial processes, running processes, and disposal processes. In the following description, the items are referred to as products. One product A is manufactured from one part a1 and two parts a2. The energy usage amount in the manufacture of the raw materials for parts a1 and a2 is also preferably evaluated, but 0 is set here for convenience. The energy used varies depending on the process, such as gasoline or renewable energy, but all energy usage is converted into a single unit (MJ) by using a conversion means. This allows various energy usage amounts to be evaluated by the same indicator. However, the indicator is not limited to MJ, and other existing units may be used, or a new index may be adopted. The conversion means can be provided as a part of the program in input resource calculation server 26. In the following description, E1 denotes green energy, E2 denotes blue energy, and E3 denotes gray energy.

### (1) Initial Process Conversion Energy (I-Converted Energy)

The process is shown in FIG. 3A.
Process 1: 10 pieces of part a1 are manufactured at part manufacturing factory 12A in sub-area A
Process 2:20 pieces of part a2 are manufactured at part manufacturing factory 12B in sub-area A.
   The I-converted energy required to manufacture parts a1 (10 pieces)+a2 (20 pieces) is:
   Let E1=300 MJ, E2=900 MJ, and E3=1,800 MJ.
   FIG. 4A shows the I-converted energy for manufacturing parts a1 (10 pieces)+a2 (20 pieces).
Process 3:10 pieces of parts a1+a2 are processed at product manufacturing factory 12C in sub-area A (Processing 1)
   Energy: Coal-fired power plant (with CCUS (carbon dioxide recovery and storage)
   Work content: A 1-kW machine is operated for 20 days (7 hours/day)
   Measurement method: Smart meter (electricity meter)
   Energy usage amount: 140 kWh
   Energy conversion value: 3.6 MJ/kWh
   Converted energy (E2): 140 kWh×3.6 MJ/kWh=504 MJ
Process 4:10 pieces of parts a1+a2 are processed in product manufacturing factory 12C in sub-area A (Processing 2)
   Energy: Heavy oil C
   Work content: Heating with an oil burner for 5 days (2 hours/day) using 10 L/h of heavy oil
   Measurement method: Smart oil meter (volume flow meter)
   Energy usage amount: 100 L
   Energy conversion value: 41.7 MJ/L
   Converted equivalent energy (E3): 100 L×41.7 MJ/L=4,170 MJ
Process 5: Transport parts a1+a2 to product manufacturing factory 12E in sub-area B
   Energy: Gasoline
   Work content: Transporting products (distance: 400 km, fuel consumption: 8 km/L)
   Measurement method: Smart fuel gauge, smart fuel consumption meter
   Energy usage amount: 50 L
   Energy conversion value: 34.6 MJ/L
   Converted energy (E3): 50 L×34.6 MJ/L=1,730 MJ
Process 6:10 pieces of product A are manufactured at product manufacturing factory 12E in sub-area B (Processing 3)
   Energy: Renewable Energy
   Work content: A 5-KW machine is operated for 10 days (7 hours/day)
   Measurement method: Smart meter (electricity meter)
   Energy usage amount: 350 kWh
   Energy conversion value: 3.6 MJ/kWh
   Converted energy (E1): 350 kWh×3.6 MJ/kWh=1,260 MJ

The method for calculating the I-converted energy per unit of product A is shown below.

The converted energy required to produce product A (10 pieces) is:
E1=1,260 MJ, E2=504 MJ, E3=4,170+1,730=5,900 MJ.

Therefore, E1+E2+E3=10,664 MJ (breakdown below):

$$E 1 = 300 + 1 , 260 = 1 , 560 MJ ( 15 \% )$$

$$E 2 = 504 + 900 = 1 , 404 MJ ( 13 \% )$$

$$E 3 = 1 , 800 + 5 , 900 = 7 , 700 MJ ( 72 \% )$$

From the above, the I-converted energy per unit of product A=10,664 MJ/10 pieces=1066.4 MJ

FIG. 4B shows the I-converted energy required to produce one piece of product A.

### (2) Running Process Converted Energy (R-Converted Energy)

One piece of product A is used (operated) in product usage facility 12D in sub-area B.
Power consumption: 500 Wh
The breakdown of electric energy is as follows:
Renewable energy: 15%
Coal-fired power plants (with CCUS): 25%
Coal-fired power plants (without CCUS): 60%
Operating time: 300 days (8 hours/day)
Measurement method: Smart meter (electricity meter), HEMS
Energy usage amount: 0.5 kWh×300 days×8 hours×3.6 MJ/kWh=4,320 MJ (energy conversion not required)
R-converted energy per unit of product A: 4,320 MJ (breakdown below)
E1=648 MJ (15%)
E2=1,080 MJ (25%)
E3=2,592 MJ (60%)

FIG. 4C shows the R-converted energy required to use one piece of product A.
(I+R)-converted energy of Product A (1): 5,386.4 MJ (breakdown as follows)

$$E 1 = 156 + 648 = 804 MJ ( 15 \% )$$

$$E 2 = 140.4 + 1 , 080 = 1 , 220.4 MJ ( 23 \% )$$

$$E 3 = 770 + 2 , 592 = 3 , 362 MJ ( 62 \% )$$

FIG. 4D shows the (I+R)-converted energy required to use one piece of product A.

### (3) Disposal Process Conversion Energy (S-Converted Energy)

The process is shown in FIG. 3B.

### (a) Reuse

In product recycling facility 12F in sub-area B, product A is recycled (reused) as new product A′. Since the energy usage amount for reuse is 0, the S-converted energy is 0. However, since product A uses I-converted energy and R-converted energy, the (I+R)-converted energy of product A′ is equal to the (I+R)-converted energy of product A. In addition, the (I+R+S)-converted energy of product A′ is also equal to the (I+R)-converted energy of product A.

### (b) Recycling and Disposal

After product A is disassembled into parts a1 and a2, part a1 is incinerated in incineration plant 12G and then disposed of in landfill in landfill factory 12H, and part a2 is recycled in recycling facility 12I.
Process 1: Transport one piece of part a1 to incineration plant 12G in sub-area C
   Energy: Gasoline
   Work content: Transport of part a1 (distance: 80 km, fuel consumption 8 km/L)
   Measurement method: Smart fuel gauge, smart fuel consumption meter
   Energy usage amount: 10 L
   Energy conversion value: 34.6 MJ/L
   Converted energy (E3): 10 L×34.6 MJ/L=346 MJ
Process 2: Incinerate part a1 in incineration plant 12G in sub-area C.
   Energy: Heavy oil C
   Work content: Heating in an incinerator for 1 hour using 1 L/h of heavy oil.
   Measurement method: Smart oil meter (volume flow meter)
   Energy usage amount: 1 L
   Energy conversion value: 41.7 MJ/L
   Converted energy (E3): 1 L×41.7 MJ/L=41.7 MJ
Process 3: Transporting incinerated waste to landfill factory 12H in sub-area C
Energy: Gasoline
Work content: Transporting incinerated waste (distance: 40 km, fuel consumption: 8 km/L)
   Measurement method: Smart fuel gauge, smart fuel consumption meter
   Energy usage amount: 5 L
   Energy conversion value: 34.6 MJ/L
   Converted energy (E3): 5 L×34.6 MJ/L=173 MJ
Process 4: The incinerated waste is landfilled at landfill factory 12H in sub-area C.
   Energy: Diesel
   Work content: Landfilling of incinerated waste (1 hour, fuel consumption 4 L/h)
   Measurement method: Smart oil meter (volume flow meter)
   Energy usage amount: 4 L
   Energy conversion value: 38.2 MJ/L
   Converted energy (E3): 4 L×38.2 MJ/L=152.8 MJ
Process 5: Transport two pieces of part a2 to recycling facility 12I in sub-area C.
   Energy: Gasoline
   Work content: Transport of part a2 (distance: 200 km, fuel consumption 8 km/L)
   Measurement method: Smart fuel gauge, smart fuel consumption meter
   Energy usage amount: 25 L
   Energy conversion value: 34.6 MJ/L
   Converted energy (E3): 25 L×34.6 MJ/L=865 MJ
   The method for calculating the (I+R+S)-converted energy per unit of product A is shown below.

The energy required for recycling and disposal of one piece of product A is:

$$E 3 = 346 + 41.7 + 173 + 152.8 + 865 = 1 , 578.5 MJ .$$

Therefore, E1+E2+E3=6,964.9 MJ (breakdown below).
E1=804 MJ (11%)
E2=1,220.4 MJ (18%)

$$E 3 = 3 , 362 + 1 , 578.5 = 4940.5 MJ ( 71 \% )$$

FIG. 4E shows the (I+R+S)-converted energy per unit of product A.

Each time each of the above processes is completed, the energy usage amounts are transmitted to database 22. Database 22 stores the amount and breakdown (classification of E1 to E3) of energy used for each of parts a1, a2, and product A, and when the energy usage amount in a new process is transmitted to database 22, the amount and breakdown of energy used for parts a1, a2, and product A are updated. Since the life cycle of part a1 ends with the landfill process, the life-cycle energy of part a1 is determined at the time when landfill process is completed. Since part a2 is treated as new part a2′ after being transported to recycling facility 12I, the life-cycle energy of part a2 is determined at the time of being transported to recycling facility 12I. Since the life cycle energy of parts a1 and a2 is determined, the life cycle energy of product A is also determined. Therefore, FIG. 4E shows the life cycle energy per unit of product A. Here, the life cycle energy is evaluated as (I+R+S), but it may be evaluated as one of I, R, or S alone or as a combination of two.

The fluid resource usage amount can be evaluated in the same way as the energy usage amount. This allows an assessment of how much water was used in the manufacture and operation of the item. The energy used to produce water can be calculated and recorded as part of the energy usage amount of parts a1, a2, and product A as necessary. In this case, the energy usage amounts can be classified into categories E1 to E3 as described above. In addition, since a lot of energy is used to improve water quality, the used water can be classified by water quality classifications (number of particles, ion concentration, etc.).

For routine processes, instead of measuring the energy usage amount and the fluid resource usage amount per item or per service, the reference energy consumption amounts and the reference fluid resource consumption amounts can be used. The reference energy consumption amounts and the reference fluid resource consumption amounts are stored in advance in database 22 together with the corresponding reference process. Input resource calculation server 26 compares the processing of the item or service to be measured with the reference process stored in database 22 and stores the reference energy consumption amount and the reference fluid resource consumption amount of the corresponding reference process in database 22 as the energy usage amount and the fluid resource usage amount in the process. For example, for processes 3 and 5 of the above-mentioned (3) (b) recycling and disposal, a reference energy consumption amount corresponding to the type of vehicle of transportation means 13A to be used is registered in database 22. If transportation means 13A is the same, fuel consumption is considered to be almost the same, and the energy usage amount that is registered can therefore be used as the reference energy consumption amount. Therefore, for processes 3 and 5 above, it is not necessary to measure the energy usage amount each time.

Input resource calculation server 26 calculates, as the aforementioned index, a total resource usage amount obtained by adding up the energy usage amounts obtained by the conversion means and the fluid resource usage amounts obtained by the conversion means. In database 22, various incentives corresponding to the total resource usage amount are registered. Input resource calculation server 26 selects an incentive from database 22 according to the total resource usage amount. Specific examples of incentives include:
Products with low life-cycle energy and no greenhouse gas emissions
Higher rating for service
Corporations that provide or purchase highly rated products and services will be given high points in the prime market and ESG, and individuals who provide or purchase highly rated products and services will be given electronic money points.
When disposing of products or services that have a large life cycle energy consumption and produce large greenhouse gas emissions, penalties such as additional industrial waste disposal fees and surcharges will be imposed.

Energy conservation, decarbonization, and water conservation can be accelerated by incentivizing products and services that have low life-cycle energy and that do not emit greenhouse gases, as well as products and services that have a low life-cycle water content. VPWP 1B may include operational assistance means for creating plans to reduce the energy usage amount and/or the fluid resource usage amount. The operational assistance means is constructed using, for example, Al.

Instead of using database 22 as a means for storing the energy usage amounts and the fluid resource usage amounts, a recording medium may be attached to individual items or members. The recording medium can preferably read, write, and store information by communication using electromagnetic waves such as light, radio, infrared, and submillimeter waves, an example thereof being RFID (Radio Frequency Identification), but not being limited thereto.

As described above, according to this embodiment, the energy usage amounts and the fluid resource usage amounts that are used throughout the entire life cycle of products and services can be evaluated. This method allows users to select, purchase, use, and dispose of products and services that contribute to saving energy and conserving water. “Decarbonization” can be promoted because the energy usage amount is classified in terms of CO₂ emissions. Because the life-cycle energy and CO₂ emissions of products and services are visualized, energy statistical data can be obtained from various perspectives such as by industry, manufacturer, and region. Furthermore, this statistical data can be used to make various proposals in terms of energy conservation, water conservation, and decarbonization.

Each of the above-described embodiments may also be applied to fluid resources other than water. The fluid resources may be gas, heat (hot water, cold water, etc.), hydrogen, ammonia, CO₂, etc. For example, CO₂ can be captured and reused using direct air capture (DAC). Using the same system as in the present embodiment, the captured CO₂ can be supplied to a factory that uses CO₂ (microalgae cultivation, dry ice production, etc.). Thus, when the fluid resource is other than water, “water supply” can be replaced by “transfer,” “purified water” can be replaced by “purified fluid,” “wastewater” can be replaced by “discharge,” and so on. Furthermore, for example, when targeting ammonia, a “purified water production facility” can be replaced by an “ammonia production facility,” a “water treatment facility” by an “ammonia-using facility,” a “purified water storage facility” by an “ammonia storage facility,” a “sewage and wastewater treatment facility” by an “ammonia treatment facility,” and a “sewage and wastewater storage facility” by a “used ammonia storage facility.”

### Application Example

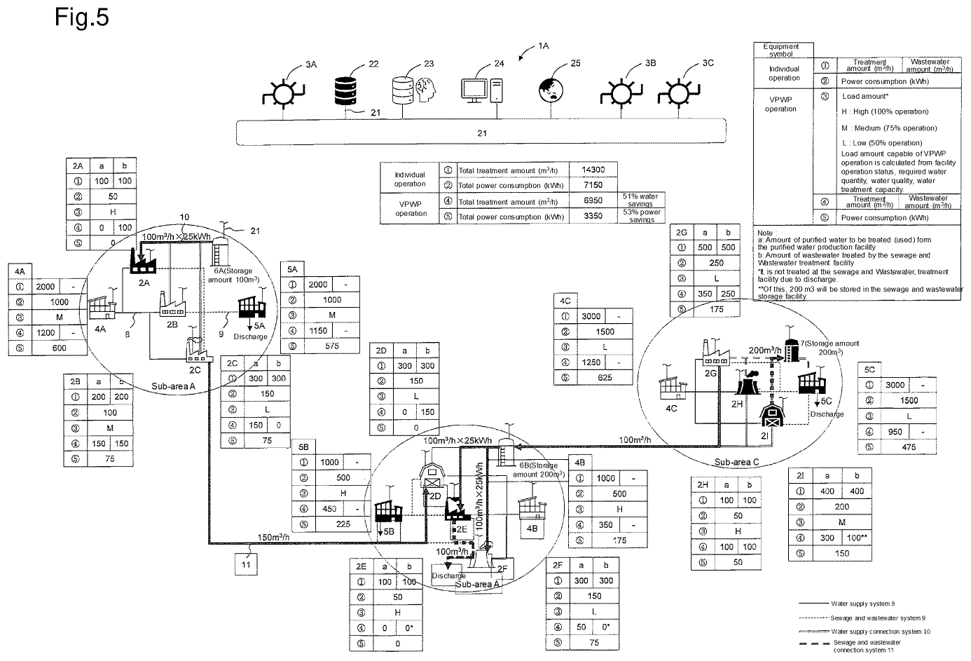

The results of applying the first embodiment to a specific example will next be described. An overview is shown in FIG. 5.

### [Sub-area A]

### [Treatment Amount]

When each facility is operated individually, water treatment facilities 2A, 2B, and 2C each operate at 100% and thus perform optimum operation (treatment) individually. Specifically, the respective treatment amounts are 100 m³/h, 200 m³/h, and 300 m³/h. Furthermore, since the treatment amounts of purified water production facility 4A and sewage and wastewater treatment facility 5A are both 2,000 m³/h, the total treatment amount in sub-area A at this time is 100+200+300+2,000+2,000=4,600 m³/h. On the other hand, in the case of VPWP operation, the operational status of each facility is linked, and a load amount capable of VPWP operation is calculated from the operating status of each facility, the required water quantity, water quality, water treatment capacity, etc. In other words, purified water production facility 4A, water treatment facilities 2A, 2B, and 2C, and sewage and wastewater treatment facility 5A cooperate with each other and recognize that they are in M: medium (75% operation), H: high (100% operation), M: medium (75% operation), L: low (50% operation), and M: medium (75% operation), respectively. Since water treatment facility 2A is operating at 100% compared to 100 m³/h during individual operation, the treatment amount is also 100 m³/h during VPWP operation. However, since water treatment facility 2A receives 100 m³/h of water from purified water storage facility 6A, the treatment amount is 0 m³/h. Based on the same concept, the treatment amounts of water treatment facilities 2B and 2C are 150 m³/h and 150 m³/h, respectively. Therefore, water treatment facilities 2A, 2B, and 2C can reduce the treatment load by 100−0=100 m³/h, 200−150=50 m³/h, and 300−150=150 m³/h, respectively, compared to individual operation. In addition, since purified water production facility 4A can be operated at 75% of the individual operation (2,000 m³/h), the treatment amount is 1,500 m³/h. However, since water is saved at 100 m³/h, 50 m³/h, and 150 m³/h at water treatment facilities 2A, 2B, and 2C, respectively, in purified water production facility 4A, treatment (water purification production) of 1,500-100-50−150=1,200 m³/h will be sufficient. Therefore, water treatment facilities 2A, 2B, and 2C can reduce the treatment load by 100-0=100 m³/h, 200−150=50 m³/h, and 300−150=150 m³/h, respectively, compared to individual operation. In addition, water treatment facility 2A receives 100 m³/h of water from purified water storage facility 6A but also generates a wastewater amount of 100 m³/h during VPWP operation. Based on the same concept, the wastewater amount of water treatment facility 2B is 150 m³/h. Since water treatment facility 2C operates at 50% of the 300 m³/h during individual operation, the wastewater amount is 150 m³/h during VPWP operation. However, because the water is sent to water treatment facility 2D in sub-area B, the water is not supplied to sewage treatment facility 5A. Therefore, water treatment facilities 2A, 2B, and 2C can reduce the wastewater treatment load of sewage and wastewater treatment facility 5A by 100−100=0 m³/h, 200−150=50 m³/h, and 300−0=300 m³/h, respectively, compared to individual operation. In addition, since sewage and wastewater treatment facility 5A can be operated at 75% of the individual operation (2,000 m³/h), the treatment amount is 1,500 m³/h. However, since water treatment facilities 2A, 2B, and 2C can reduce the sewage and wastewater treatment load by 0 m³/h, 50 m³/h, and 300 m³/h, respectively, the sewage and wastewater treatment amount of 1,5000−50−300=1,150 m³/h will be sufficient.

Therefore, the treatment amount of all facilities in sub-area A (purified water production facility 4A, water treatment facilities 2A, 2B, and 2C, sewage and wastewater treatment facility 5A, and purified water storage facility 6A) in the case of VPWP operation is 1,200+0+150+150+1,150+100=2,750 m³/h. Therefore, the treatment amount during the VPWP operation in sub-area A can be reduced by 4,600−2,750=1,850 m³/h compared to the individual operation.

### [Power Consumption]

Assuming that the power consumption is 50% of the treatment amount, the power consumption of purified water production facility 4A, water treatment facilities 2A, 2B, and 2C, and sewage and wastewater treatment facility 5A in the case of individual operation is 1,000, 50, 100, 150, and 1,000 kWh, respectively. On the other hand, the power consumption of purified water production facility 4A, water treatment facilities 2A, 2B, and 2C, and sewage and wastewater treatment facility 5A in the case of VPWP operation is 600 (1,200+2), 0 (because the treatment amount=0 m³/h), 75 (150+2), 75 (150+2), 575 (1,150+2), and 25 (power consumption for receiving water from 6A) kWh, respectively. Therefore, the total power consumption in the case of individual operation is 1,000+50+100+150+1,000=2,300 kWh, while the total power consumption in the case of VPWP operation is 600+0+75+75+575+25=1,350 kWh, for a saving of 2,300−1350=950 kWh.

### [Sub-Areas B and C]

Similarly, the treatment amount of all facilities in sub-area B (purified water production facility 4B, water treatment facilities 2D, 2E, and 2F, sewage and wastewater treatment facility 5B, and purified water storage facility 6B) during VPWP operation is 350+0+0+50+450+200=1,050 m³/h. Therefore, the treatment amount can be reduced by 1,650 m³/h compared to individual operation (2,700 m³/h), and as a result, the power consumption saved is 825 kWh. The treatment amount of all facilities in sub-area C (purified water production facility 4C, water treatment facilities 2G, 2H, and 2I, sewage and wastewater treatment facility 5C, and purified water/sewage and wastewater storage facility 7) during VPWP operation is 1,250+350+100+300+950+200=3,150 m³/h. Therefore, the treatment amount can be reduced by 3,850 m³/h compared to individual operation (7,000 m³/h), and as a result, the power consumption saved is 2,025 kWh. As a result of the above, the total treatment amount of sub-areas A to C was reduced by approximately 5, 121% compared to individual operation (14,300 m³/h), and the total power consumption of sub-areas A to C was reduced by approximately 5,323% compared to the individual operation (7,150 kWh).

Although preferred embodiments of the present invention have been shown and described in detail, it will be understood that various changes and modifications can be made therein without departing from the spirit or scope of the appended claims.

### EXPLANATION OF REFERENCE NUMBERS

1A, 1B VPWP
A to C sub-area
2A to 2I water treatment facility
3A to 3C power Plant
4A to 4C purified water production facility
5A to 5C sewage and wastewater treatment facility
6A, 6B purified water storage facility
7 sewerage and wastewater storage facility
8 water supply system
9 sewerage and wastewater system
10 water supply connection system
11 sewerage and wastewater connection system
12A, 12B part manufacturing factory
12C, 12E product manufacturing factory
12D product use facility
12F product recycling facility
12G incineration plant
12H landfill factory
12I recycling facility
13A to 13C transportation means
21 communications network
22 database
23 operation plan creation server
24 control server
25 internet browsing terminal
26 input resource calculation server

1. A virtual power fluid plant that adjusts a balance between a supply and consumption of electrical energy and a supply and consumption of a fluid resource in a predetermined area, said virtual power fluid plant comprising:
a plurality of electrical-related facilities that are installed in the predetermined area and that perform at least one of supplying, utilizing, and storing electrical energy;
a plurality of fluid-related facilities that are installed in the predetermined area and that perform at least one of supplying, processing, and storing a fluid resource;
an operation plan creation means for creating an operation plan for at least one of the electrical-related facilities and at least one of the fluid-related facilities; and
a control means for controlling an operation of the at least one electrical-related facility and the at least one fluid-related facility based on the operation plan created by the operation plan creating means.

2. The virtual power fluid plant according to claim 1, further comprising a database that stores operation-related data for the plurality of electrical-related facilities and the plurality of fluid-related facilities, wherein the operation plan creation means creates the operation plan based on the operation-related data stored in the database.

3. The virtual power fluid plant according to claim 2, wherein
the fluid resource is water,
the plurality of fluid-related facilities includes a purified water production facility that produces purified water, water treatment facilities that treat the purified water supplied from the purified water production facility, and a purified water storage facility that stores the treated purified water supplied from the water treatment facilities, each water treatment facility including purified water feed equipment that can deliver purified water to the outside,
the database includes a purified water production capacity of the purified water production facility, a purified water demand of each water treatment facility, an amount of feedable purified water of the purified water feed equipment, and an amount of storable purified water of the purified water storage facility, and
the operation plan creation means creates a water operation plan including a supply of purified water from the purified water production facility to the water treatment facilities, an interchange of purified water between the water treatment facilities, a storage of purified water in the purified water storage facility, and a supply of purified water from the purified water storage facility to each water treatment facility based on the purified water production capacity of the purified water production facility, the purified water demand of each water treatment facility, the amount of feedable purified water of the purified water feed equipment, and the amount of storable purified water of the purified water storage facility.

4. The virtual power fluid plant according to claim 3, wherein
the database includes at least one of a change over time of an electricity cost, a change over time of an electricity supply and demand, and a change over time of a purified water demand at the water treatment facilities, and
the water operation plan includes having the purified water production facility produce purified water and store the produced purified water in the purified water storage facility at a time when any one of the electricity cost, the power demand, and the purified water demand is low, and supplying the purified water stored in the purified water storage facility to the water treatment facility at a time when any one of the electricity cost, the power demand, and the purified water demand is high.

5. The virtual power fluid plant according to claim 2, wherein
the fluid resource is water,
the plurality of fluid-related facilities includes water treatment facilities that treat purified water, a sewage and wastewater treatment facility that treats sewage and wastewater discharged from the water treatment facilities, and a sewage and wastewater storage facility that stores the sewage and wastewater discharged from the water treatment facilities,
the database includes a sewage and wastewater amount from each water treatment facility, a sewage and wastewater treatment capacity of the sewage and wastewater treatment facility, and an amount of storable sewage and wastewater of the sewage and wastewater storage facility, and
the operation plan creation means creates a plan to distribute the sewage and wastewater from each water treatment facility to the sewage and wastewater treatment facility and the sewage and wastewater storage facility based on the sewage and wastewater amount from each water treatment facility, the sewage and wastewater treatment capacity of the sewage and wastewater treatment facility, and the amount of storable sewage and wastewater of the sewage and wastewater storage facility.

6. The virtual power fluid plant according to claim 5, wherein
the database includes at least one of a change over time of an electricity cost, a change over time of an electricity supply and demand, and a change over time of a sewage and wastewater amount of the water treatment facilities, and
the water operation plan includes increasing a ratio of sewage and wastewater to be distributed to the sewage and wastewater treatment facility when any one of the electricity cost, the power demand, or the sewage and wastewater amount is low, and increasing a ratio of sewage and wastewater to be distributed to the sewage and wastewater storage facility at a time when any one of the electricity cost, the power demand, or the sewage and wastewater amount is high.

7. The virtual power fluid plant according to claim 2, wherein
the fluid resource is water,
the plurality of fluid-related facilities includes a plurality of water treatment facilities and a sewage and wastewater storage facility that stores sewage and wastewater discharged from the water treatment facilities,
the database includes a required water quality of the water to be supplied to each water treatment facility, a sewage and wastewater quality of the sewage and wastewater discharged from each water treatment facility, and an amount of storable sewage and wastewater of the sewage and wastewater storage facility, and
the operation plan creation means creates a water operation plan including supplying sewage and wastewater discharged from some of the water treatment facilities to other water treatment facilities, storing the sewage and wastewater in the sewage and wastewater storage facility, and supplying the sewage and wastewater stored in the sewage and wastewater storage facility to the other water treatment facilities based on the required water quality, the sewage and wastewater quality, and the amount of storable sewage and wastewater of the sewage and wastewater storage facility.

8. The virtual power fluid plant according to claim 3, wherein the predetermined area is divided into a plurality of sub-areas, and the water operation plan is created for each of the sub-areas.

9. The virtual power fluid plant according to claim 1, wherein the plurality of electricity-related facilities includes a power plant, an electricity utilization facility, and energy storage equipment.

10. The virtual power fluid plant according to claim 1, further comprising a database that stores, for each process in a manufacture of an item or for each process in a provision of a service, an energy usage amount and a fluid resource usage amount for each of the processes, and
input resource calculation means for integrating the energy usage amounts and the fluid resource usage amounts stored in the database for each of the processes to calculate a total energy usage amount and a total fluid resource usage amount.

11. A method for operating a virtual power fluid plant that balances between a supply and consumption of electrical energy and a supply and consumption of a fluid resource in a predetermined area, said method comprising:
storing, in a database, operation-related data of a plurality of electrical-related facilities that are installed in the specified area and that perform at least one of supplying, consuming, and storing electrical power, and operation-related data of a plurality of fluid-related facilities that are installed in the specified area and that perform at least one of supplying, utilizing, treating, and storing a fluid resource;
creating, by an operation plan creation means, an operation plan for at least one of the electrical-related facilities and at least one of the fluid-related facilities based on the operation-related data stored in the database; and
controlling, by an operation plan creation means, an operation of the at least one electrical-related facility and the at least one fluid-related facility based on the operation plan created by the operation plan creation means.

12. A system for evaluating input resources in a manufacture of an item or a provision of a service in the virtual power fluid plant according to claim 1, comprising:
storage means for storing, for each process in a manufacture of an item or for each process in a provision of a service, an energy usage amount and a fluid resource usage amount for each of the processes; and
input resource calculation means for integrating the energy usage amounts and the fluid resource usage amounts stored in the storage means for each of the processes to calculate a total energy usage amount and a total fluid resource usage amount.

13. The input resource evaluation system according to claim 12, wherein the storage means stores energy usage amounts and fluid resource usage amounts in each process of operation, recycling, and disposal of the item, and the input resource calculation means calculates a total energy usage amount and a total fluid resource usage amount including the energy usage amounts and the fluid resource usage amounts in each process of operation, recycling, and disposal of the item.

14. The input resource evaluation system according to claim 13, wherein the storage means is a database, the database is connected via a communication line to each facility related to the processes in the manufacture, operation, recycling, and disposal of the item, and the energy usage amounts and the fluid resource usage amounts at each facility are stored online in the database.

15. The input resource evaluation system according to claim 13, wherein
the storage means is a database, the database is connected via a communication line to each facility related to the processes in the manufacture, operation, recycling, and disposal of the item,
the database stores a reference process, a reference energy usage amount, and a reference fluid resource usage amount used in the reference process, and
the input resource calculation means compares the processes with the reference process stored in the database, and stores in the database the reference energy usage amount and reference fluid resource usage amount of the corresponding reference process as the energy usage amount and the fluid resource usage amount in the processes.

16. The input resource evaluation system according to claim 12, further comprising operation support means for creating a plan that reduces at least one of the energy usage amounts and the fluid resource usage amounts.

17. The input resource evaluation system according to claim 12, further comprising classification means for classifying the energy usage amount into a plurality of energy categories from a viewpoint of greenhouse gas emissions,
wherein the storage means stores the energy category identified by the classification means for each process.

18. The input resource evaluation system according to claim 12, wherein the storage means stores energy usage amounts required for producing or treating the fluid resource.

19. The input resource evaluation system according to claim 12, further comprising conversion means for evaluating the energy usage amounts in each process with a same index.

20. The input resource evaluation system according to claim 19, wherein
the input resource calculation means calculates a total resource usage amount by adding up the indexes of the energy usage amounts and the fluid resource usage amounts obtained by the conversion means,
the database stores the total resource usage amount and an incentive corresponding to the total resource usage amount, and
the input resource calculation means selects from the database the incentive according to the total resource usage amount.
